(19) United States
(12) Patent Application Publication
(10) Pub. No.: US 2006/0112671 A1
(43) Pub. Date: Jun. 1, 2006

(54) Arrangement of cross-members which are connected by connecting elements

(76) Inventors: Gunter Blase, Bergisch Gladbach (DE); Frank Blase, Bergisch Gladbach (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/101,184

(22) Filed: Apr. 7, 2005

(30) Foreign Application Priority Data
Apr. 8, 2004 (DE) DE202004005801.4

(51) Int. Cl. F16G 13/00

(52) U.S. Cl. 59/78.1

(57) ABSTRACT

An arrangement of cross-members (1) joined by connecting elements (2) for fastening to one side of an energy chain comprising chain links connected in articulated fashion, where the chain links each comprise two side pieces connected by a cross-element, as well as a cross-member (1), the ends of which can be snapped onto the side pieces, is intended to be suitable for small and lightweight energy chain embodiments and easy to assemble, and is therefore characterized in that the connecting elements (2) are integrally molded on the cross-members (1), and can be elastically elongated in the longitudinal direction of the arrangement when the space between the cross-members (1)

The invention relates to an arrangement of cross-members joined by connecting elements for fastening to one side of an energy chain comprising chain links connected in articulated fashion, where the chain links each comprise two side pieces connected by a cross-element, as well as a cross-member, the ends of which can be snapped onto the side pieces.

An energy chain is usually connected at one end to a stationary connection of an energy consumer, and at the other end to a connection capable of movement relative to the stationary connection. When the mobile energy consumer moves the energy chain, the section of the energy chain adjacent to the stationary connection, also referred to as the “lower run”, can be deposited on a plane base or in a guide trough. The lower is followed by a curved section of the energy chain, which transitions into the part of the energy chain adjacent to the mobile connection, also referred to as the “upper run”.

Such an arrangement of cross-members, which are designed as lids for the chain links of an energy chain, is known, where the lids have connecting elements on one side in the longitudinal direction of the chain, which are mounted in sliding fashion on the opposite side of the lid of the immediately adjacent chain link and, when fully extended, are held in place by this lid. By detaching the lid at the end of the arrangement from the corresponding chain link, the entire arrangement can be pulled off the energy chain by successively detaching the lids, owing to the interconnection of the lids.

However, fastening the connecting elements of the lids on the immediately adjacent lids is not suitable for all energy chain designs, particularly for small and lightweight parts.

The object of the present invention is to provide an arrangement of cross-members of the kind described in the opening paragraph, which is suitable for small and lightweight energy chains and simple to assemble.

According to the invention, the object is solved by an arrangement of cross-members of the kind described in the opening paragraph, in which the connecting elements are integrally molded on the cross-members, and can be elastically elongated in the longitudinal direction of the arrangement when the space between the cross-members increases.

Owing to the design according to the invention, the cross-members with the connecting elements that join them can easily be manufactured, and fastened on the side of the energy chain intended for this purpose. The cross-members with the connecting elements can be manufactured as small, lightweight parts and mounted on energy chains of this kind.

In a preferred embodiment of the invention, the connecting elements have an arched or polygonal profile between the cross-members. The connecting elements can have roughly the same cross-section over their entire length, including the arched or polygonal section. On account of their elastic flexibility, the arched or polygonal connecting elements can be pulled apart elastically when the space between the cross-members increases in the curved section of the energy chain. The connecting elements contract again when the space between the cross-members decreases during transitioning from the curved section to one of the runs.

The elasticity of the connecting elements in the longitudinal direction of the arrangement is such that the elasticity limit is not exceeded by the force required to pull the arrangement off the energy chain.

In a preferred development of the invention, the connecting elements lie in the plane formed by the cross-members, or they protrude from the side of this plane that faces outwards when the arrangement is fastened on an energy chain.

As a result of this measure, at least the connecting elements of the deflected chain links in the curved section of the energy chain protrude outwards from the interior of the chain such that they dampen the impact of the associated chain links on the plane base or the guide trough and reduce impact noise. It has been found that an arched or polygonal profile of the connecting elements in the plane formed by the second cross-members is sufficient for this purpose. When the associated chain links are deflected, connecting elements of such a shape expand outwards away from the interior of the chain and bring about a damping effect. This effect is further enhanced if the arched or polygonal connecting elements protrude outwards away from the interior of the chain even when the associated chain links are not in deflected position, where the second cross-members of the chain links lying in a single plane. The lower run of the energy chain is then dampened by the connecting elements as it descends onto the plane base or the guide trough.

In a preferred embodiment of the invention, the profile of the connecting elements is mirror-symmetrical to the center transverse planes, which are parallel to the cross-members, located in the middle between them, and perpendicular to the plane formed by the cross-members.

In another expedient embodiment, the profile of the connecting elements is mirror-symmetrical to the center longitudinal planes, which are perpendicular to the longitudinal direction of the cross-members and located in the middle between the ends of the cross-members.

In this context, the connecting elements can have a U-shaped arch extending towards the center longitudinal plane.

In another embodiment, the connecting elements can have a V-shaped profile extending towards the center longitudinal plane.

In a further variation, the connecting elements can have a rectangular profile extending towards the center longitudinal plane.

Expediently, the width of the connecting elements, measured in the longitudinal direction of the cross-members, is less than the width of the second cross-members, measured in the plane formed by the cross-members. The width of the connecting elements can be less than half the width of the cross-members. Preferably, the width of the connecting elements is less than one-third, particularly preferably less than one-fifth the width of the cross-members.

In a preferred embodiment of the invention, immediately adjacent cross-members are each joined by two connecting elements.

The two connecting elements can each be connected to one end section of the cross-members.

The connecting elements can be made of plastic and integrally molded on the plastic cross-members.

In particular, the cross-members and the connecting elements can be made of different plastic materials and manufactured by a two-component injection molding process.

The invention further relates to an energy chain with an arrangement of cross-members that are joined by connecting elements and display the characteristics described above.

Practical examples of the present invention are described below in more detail on the basis of the drawing. The drawing shows the following:

FIG. 1 A perspective view of an arrangement of cross-members joined by connecting elements,

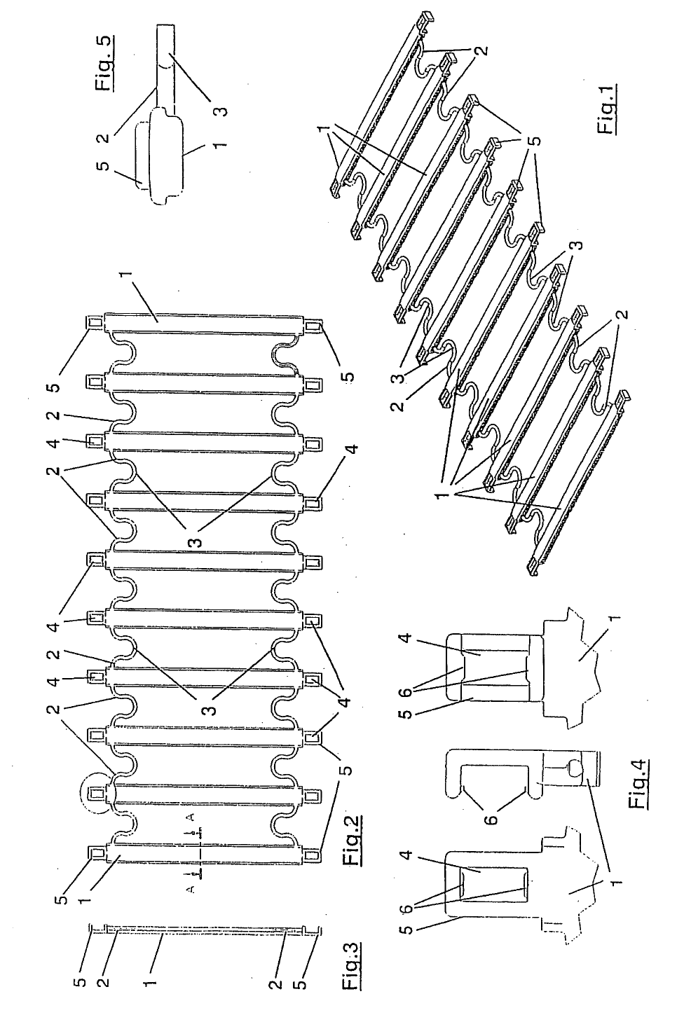

FIG. 2 A top view of the arrangement shown in FIG. 1,

FIG. 3 A front view of the arrangement shown in FIG. 1,

FIG. 4 An enlarged top, side and bottom view of the ends of the cross-members, marked by a circle in FIG. 2,

FIG. 5 A cross-section of a cross-member along Line A-A in FIG. 2,

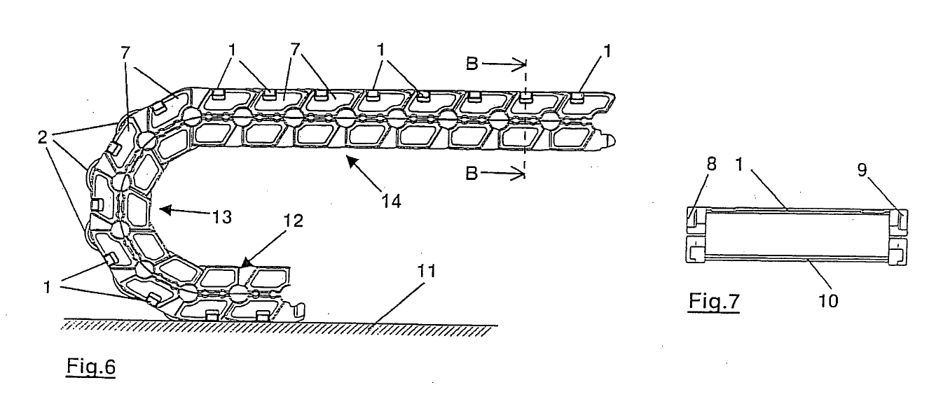

FIG. 6 A side view of an energy chain with the arrangement of cross-members shown in FIGS. 1 to 5,

FIG. 7 A front view of a chain link of the energy chain shown in FIG. 6,

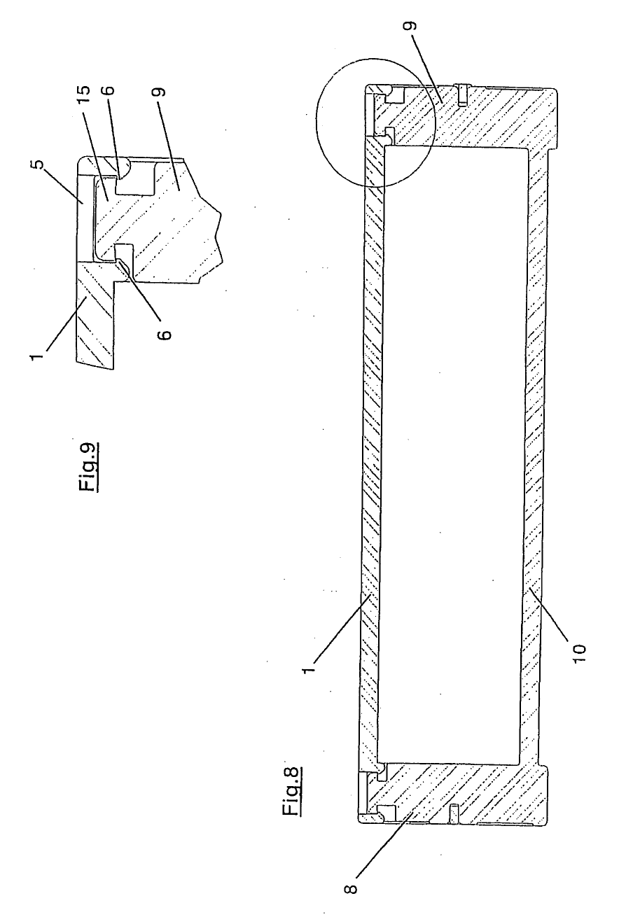

FIG. 8 A cross-section of a chain link along Line B-B in FIG. 6,

FIG. 9 An enlarged view of the area marked by a circle in the cross-sectional diagram in FIG. 8,

FIG. 10 A perspective view of a second practical example of an arrangement of cross-members joined by connecting elements,

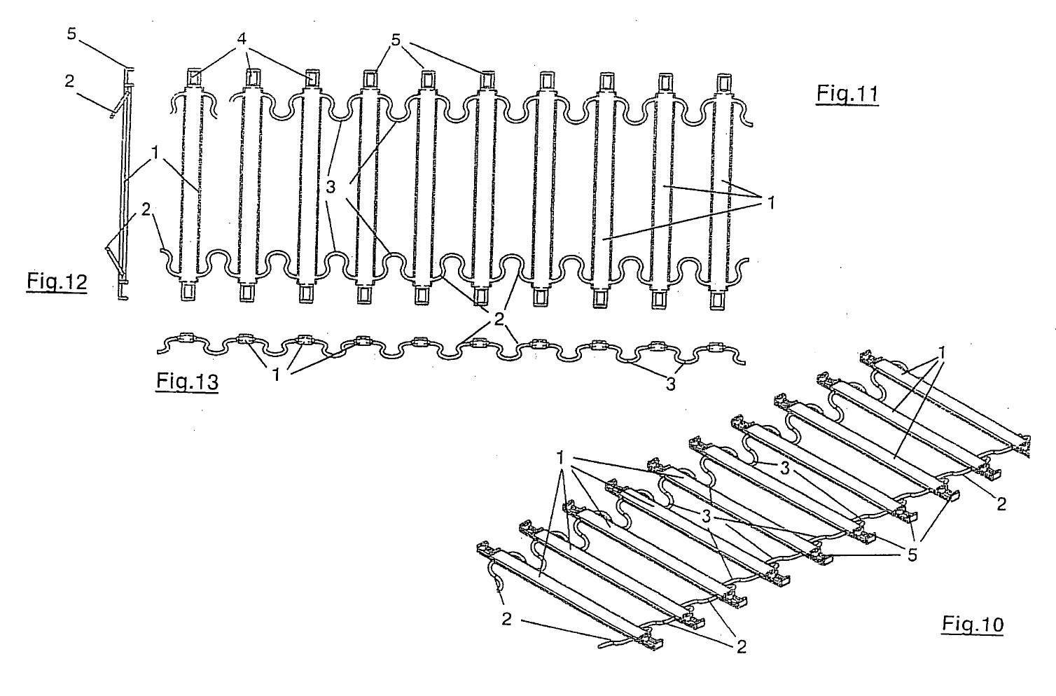

FIG. 11 A top view of the arrangement shown in FIG. 10,

FIG. 12 A front view of the arrangement shown in FIG. 10,

FIG. 13 A side view of the arrangement shown in FIG. 10,

FIG. 14 A side view of an energy chain with the arrangement of cross-members shown in FIGS. 10 to 13,

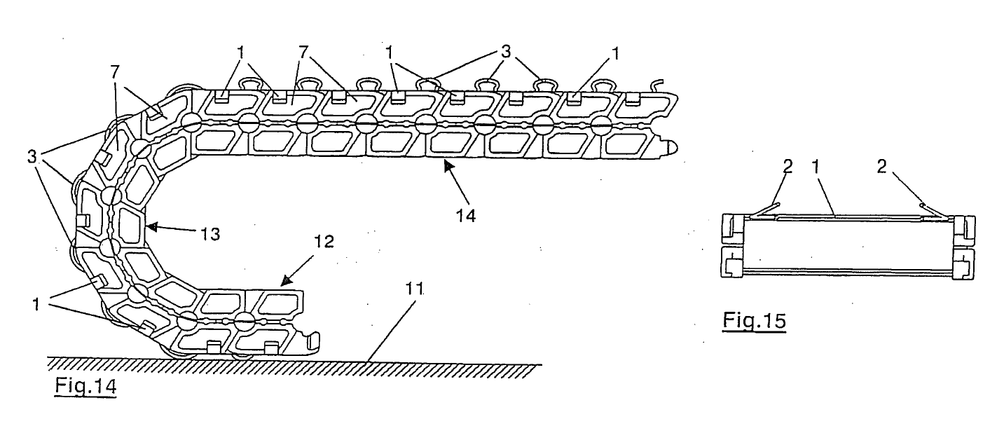

FIG. 15 A front view of a chain link of the energy chain,

FIG. 16 A third practical example of an arrangement of cross-members joined by connecting elements,

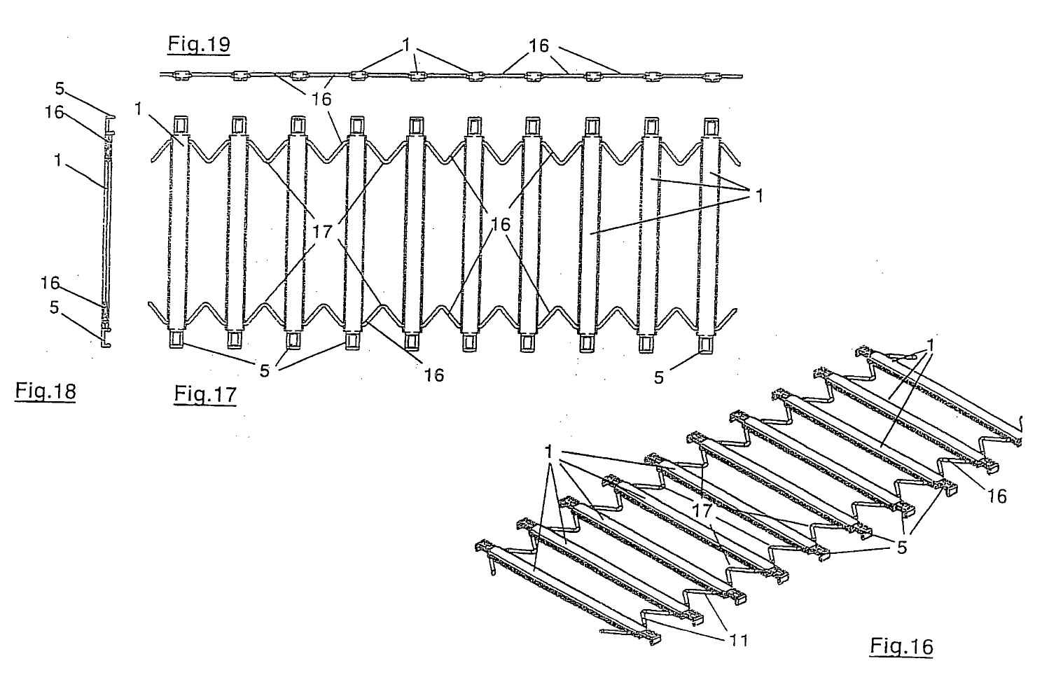

FIG. 17 A top view of the arrangement shown in FIG. 16,

FIG. 18 A front view of the arrangement shown in FIG. 16,

FIG. 19 A view of the arrangement shown in FIG. 16,

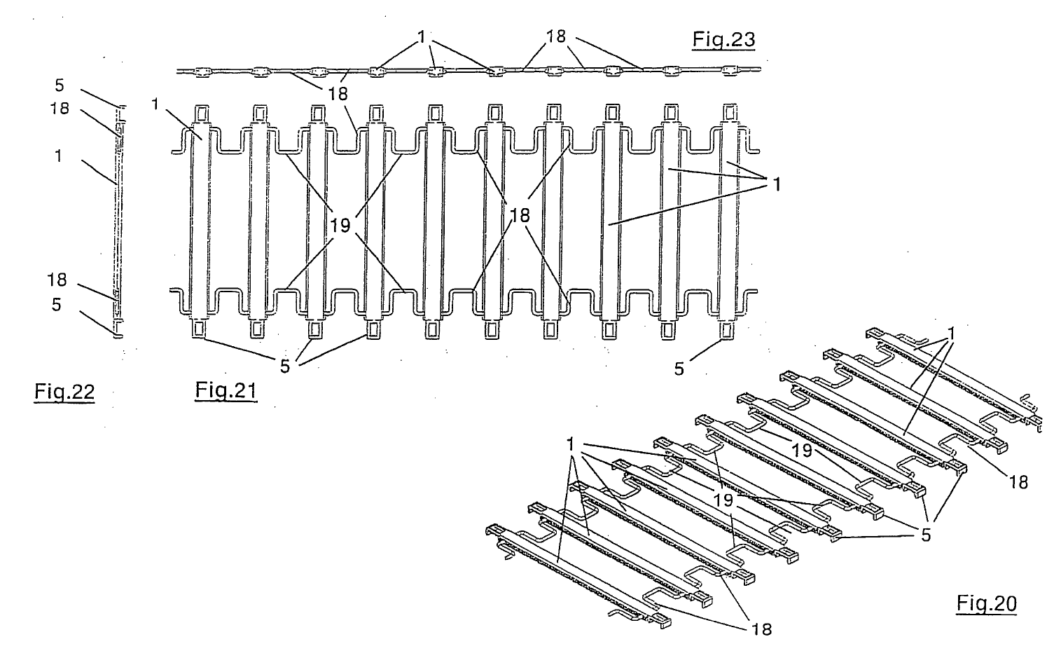

FIG. 20 A fourth practical example of an arrangement of cross-members joined by connecting elements,

FIG. 21 A top view of the arrangement shown in FIG. 20,

FIG. 22 A front view of the arrangement shown in FIG. 20, and

FIG. 23 A side view of the arrangement shown in FIG. 20.

As initially shown in FIGS. 1 and 2, the arrangement of cross-members 1 joined by connecting elements 2 is designed such that connecting elements 2, made of an elastic, flexible material, display an arched profile in the plane formed by the second cross-members 1. The profile of connecting elements 2 is mirror-symmetrical to the center longitudinal plane, which is perpendicular to the longitudinal direction of cross-members 1 and runs through their center. Furthermore, the profile of connecting elements 2 is mirror-symmetrical to the center transverse planes, which are located in the center between immediately adjacent cross-members, and perpendicular to the plane formed by cross-members 1.

Connecting elements 2 are integrally molded on cross-members 1, such that the entire arrangement of cross-members 1 joined by connecting elements 2, shown in FIGS. 1 and 2, is a single piece.

As FIGS. 1 and 2 further show, immediately adjacent cross-members 1 are connected to one another on their end sections by two connecting elements 2. In the longitudinal direction of the arrangements shown in FIGS. 1 and 2, connecting elements 2 are joined to cross-members 1 at opposite points, and their central regions display a U-shaped arch 3 extending towards the center longitudinal plane of the arrangement. Inward-facing arches 3 are located in the plane formed by cross-members 1. If the arrangement of cross-members 1 joined by connecting elements 2 shown in FIGS. 1 and 2 is bent in the center longitudinal plane, arches 3 of connecting elements 2 expand outwards away from the curved surface formed by cross-members 1.

If the arrangement of cross-members 1 is fastened on the outside of an energy chain—comprising a lower run connected to a stationary connecting element, followed by a curved section and an upper run connected to a mobile connecting element—arches 3 protruding outwards in the curved section come into contact with the plane base or guide trough, on which the lower run of the energy chain is deposited. As a result of the elastic, flexible design of connecting elements 2, they dampen the impact and reduce noise.

For fastening on the side pieces of the chain links of an energy chain, the ends of cross-members 1, as shown in FIGS. 2 and 4, have window-like cut-outs 4 in the plane formed by cross-members 1. The end regions of cross-members 1 are U-shaped in a cross-sectional plane running in the longitudinal direction of cross-members 1, as shown particularly clearly in FIGS. 3 and 4. The ends of the legs of the U-shaped end regions 5 are provided with inward-facing projections 6 for fastening cross-members 1 on the opposite side pieces of a chain link.

FIGS. 6 and 7 show a section of an energy chain, with the arrangement of cross-members 1 shown in FIGS. 1 to 5 fastened on the outside.

Chain links 7 each have two side pieces 8 and 9, which are connected by cross-element 10, and a cross-member 1, the ends of which are snapped onto side pieces 8 and 9. Side pieces 8 and 9 form a U-shaped profile together with cross-element 10, which is integrally molded in the region of a longitudinal edge (FIG. 7, bottom).

As shown in FIG. 6, chain links 7 form lower run 12, which is deposited on plane base 11 and connected to a stationary connecting element of the chain (not shown in the Figure), followed by curved section 13, which in turn transitions into upper run 14, which is connected to a mobile connecting element of a mobile energy consumer (not shown in the Figure).

In curved section 13 of the energy chain, the space between cross-members 1 increases compared to the distance between cross-members 1 in lower run 12 and upper run 14. As a result of this increased spacing, connecting elements 2 in the plane of cross-members 1 are pulled apart elastically along their arched segments. The tensile forces act on the ends of connecting elements 2 such that the U-shaped arches extending transversely to the longitudinal direction of the chain expand outwards away from the interior of the chain. Outwardly protruding arches 3 dampen the impact of chain links 7, which are deposited on base 11 as they move through curved section 13 and into lower run 12. Because connecting elements 2 come into contact with base 11 as they transition from curved section 13 to lower run 12, they are subjected to elastic deformation, meaning that, as chain links 7 are deposited on base 11, some of their kinetic energy is converted into deformation energy in connecting elements 2. This results in a damping effect and noise reduction.

In order to snap cross-members 1 onto side pieces 8 and 9 of a chain link 7, the associated fastening areas of side pieces 8 and 9 are provided at the top edges (in FIGS. 8 and 9) with sections 15 of T-shaped cross-section. The cross-sectional width of the horizontal T-bar of sections 15 roughly corresponds to the inside space between the legs of U-shaped end regions 5 of cross-members 1. The height of projections 6, which are integrally molded on the inside of the legs, to the base of U-shaped end regions 5 is roughly equal to the height of the horizontal T-bar of sections 15. When U-shaped end regions 5 are placed on T-shaped sections 15 of side pieces 8 and 9, projections 6 snap under the horizontal T-bar of T-shaped sections 15. This results in a stable snap connection between cross-members 1 and side pieces 8 and 9, which is easy to detach, meaning that the arrangement of cross-members 1 can easily be pulled off the energy chain by hand.

The practical example shown in FIGS. 10 to 13 differs from the practical example described above on the basis of FIGS. 1 to 5 in that connecting elements 2, which display an arch profile, do not lie in the plane formed by cross-members 1, but rather extend out of this plane towards the center longitudinal plane of cross-members 1.

The ends of cross-members 1 are similarly provided with fastening areas, which are perpendicular to their plane. While the fastening areas face downwards in FIG. 1, they face upwards in FIG. 10. Therefore, connecting elements 2 extend downwards from the plane formed by cross-members 1, as shown in FIG. 10.

As shown particularly clearly in FIGS. 12 and 13, U-shaped arches 3 of connecting elements 2 extend downwards from the plane of cross-members 1.

If the arrangement of cross-members shown in FIGS. 10 to 13 is fastened on the outside of an energy chain, i.e. on the bottom of lower run 12 and the top of upper run 14, arches 3 of connecting elements 2, which then face outwards away from the interior of the chain, come into contact along their entire surface on the bottom of lower run 12 with base 11 or the guide trough, which serves as a surface for depositing the energy chain. Thanks to these measures, a particularly good damping effect is achieved when the energy chain rolls down onto the base or into the guide trough.

A section of an energy chain of this kind is shown in FIGS. 14 and 15. Apart from connecting elements 2, which slant away from the interior of the chain towards the center, this energy chain corresponds to the one shown in FIGS. 6 and 7.

Connecting elements 2 form an elastic support in the region of lower run 12, which rests on plane base 11.

In the practical example of an arrangement of cross-members 1 joined by connecting elements 16, shown in FIGS. 16 to 19, connecting elements 16 have a V-shaped profile extending towards the center longitudinal plane. Connecting elements 16 with V-shaped profile 17 lie in the plane formed by cross-members 1, as shown particularly clearly in FIGS. 18 and 19.

V-shaped profile 17 has roughly the same effect as U-shaped arches 3 shown in FIGS. 1 and 2.

The practical example shown in FIGS. 20 to 23 differs from the practical example described above on the basis of FIGS. 16 to 19 in that connecting element 18 has a rectangular profile 19 extending towards the center longitudinal plane of the arrangement. Connecting element 18 with rectangular profile 19 extends in the plane formed by cross-members 1. The rectangular design of connecting element 18 has a similar effect as the embodiment of connecting elements 2 and 16 described above.

### LIST OF REFERENCE NUMBERS

1 Cross-member
2 Connecting element
3 U-shaped arch
4 Window-like cut-out
5 End region
6 Projection
7 Chain link
8 Side piece
9 Side piece
10 Cross-element
11 Base
12 Lower run
13 Curved section
14 Upper run
15 Section
16 Connecting element
17 V-shaped profile
18 Connecting element
19 Rectangular profile

1: Arrangement of cross-members joined by connecting elements for fastening to one side of an energy chain comprising chain links connected in articulated fashion, where the chain links each comprise two side pieces connected by a cross-element, as well as a cross-member, the ends of which can be snapped onto the side pieces, characterized in that the connecting elements are integrally molded on the cross-members, and can be elastically elongated in the longitudinal direction of the arrangement when the space between the cross-members increases.

2: Arrangement according to claim 1, characterized in that the connecting elements have an arched or polygonal profile between the cross-members.

3: Arrangement according to claim 1, characterized in that the connecting elements lie in the plane formed by the cross-members, or protrude from the side of this plane that faces outwards when the arrangement is fastened on an energy chain.

4: Arrangement according to claim 1, characterized in that the profile of the connecting elements is mirror-symmetrical to the center transverse planes, which are parallel to the cross-members, located in the middle between them, and perpendicular to the plane formed by the cross-members.

5: Arrangement according to claim 1, characterized in that the shape of the connecting elements is mirror-symmetrical to the center longitudinal planes, which are perpendicular to the longitudinal direction of the cross-members and located in the middle between the ends of the cross-members.

6: Arrangement according to claim 1, characterized in that the connecting elements have a U-shaped arch extending towards the center longitudinal plane.

7: Arrangement according to one of claim 1, characterized in that the connecting elements have a V-shaped profile extending towards the center longitudinal plane.

8: Arrangement according to one of claim 1, characterized in that the width of the connecting elements, measured in the longitudinal direction of the cross-members, is less than the width of the cross-members, measured in the plane formed by the cross-members.

9: Arrangement according to claim 8, characterized in that the width of the connecting elements is at least one-half less than the width of the cross-members.

10: Arrangement according to claim 9, characterized in that the width of the connecting elements is at least one-third less of the width of the cross-members.

11: Arrangement according to claim 10, characterized in that the width of the connecting elements is at least one-fifth less than the width of the cross-members.

12: Arrangement according to one of claim 1, characterized in that adjacent cross-members are each joined by two connecting elements.

13: Arrangement according to claim 12, characterized in that the two connecting elements are each connected to one end section of the cross-members.

14: Arrangement according to one of claim 1 characterized in that the connecting elements are made of plastic and integrally molded on the plastic cross-members.

15: Arrangement according to claim 14, characterized in that the cross-members and the connecting elements are made of different plastic materials and manufactured by a two-component injection molding process.

16: Energy chain comprising chain links connected in articulated fashion, which each comprise two side pieces connected by a cross-element, as well as a cross-member, the ends of which can be snapped onto the side pieces, where the cross-members are joined by connecting elements, characterized by an arrangement according to claim 1.
